(19) United States
(12) Patent Application Publication
(10) Pub. No.: US 2025/0202303 A1
(43) Pub. Date: Jun. 19, 2025

(54) DIRECT ROTOR BAR COOLING FOR INDUCTION MACHINES

(71) Applicant: BorgWarner Inc., Auburn Hills, MI (US)

(72) Inventor: Cong Ma, Fisher, IN (US)

(21) Appl. No.: 18/543,025

(22) Filed: Dec. 18, 2023

(51) Int. Cl. H02K 1/32; H02K 3/24; H02K 17/16

(52) U.S. Cl. CPC H02K 1/32; H02K 3/24; H02K 17/168

(57) ABSTRACT

A rotor assembly used in an induction machine including a rotor core having a plurality of conductor bar slots spaced circumferentially around the rotor core; a rotor shaft including a fluid supply channel configured to receive fluid from a fluid source; and conductor bars, received within the conductor bar slots, that receive fluid from the fluid supply channel through bores formed in the conductor bars or over an outer surface of the conductor bars.

### TECHNICAL FIELD

The present application relates to induction machines and, more particularly, to cooling rotor assemblies of induction machines.

### BACKGROUND

Rotating electrical machines can exist in different forms. For instance, rotating electrical machines can be synchronous machines, such as permanent magnet synchronous machines. Or rotating electrical machines could be asynchronous machines, such as induction machines. Typically, the synchronous machines have a greater continuous performance rating than induction machines. That is, the induction machines may have a lower continuous speed and torque rating than the synchronous machines. One factor possibly responsible for this disadvantage may be the thermal capability of the induction machine. It would be helpful to more effectively cool induction machines to increase the continuous speed and torque rating.

### SUMMARY

In one implementation, a rotor assembly used in an induction machine including a rotor core having a plurality of conductor bar slots spaced circumferentially around the rotor core; a rotor shaft including a fluid supply channel configured to receive fluid from a fluid source; and conductor bars, received within the conductor bar slots, that receive fluid from the fluid supply channel through bores formed in the conductor bars or over an outer surface of the conductor bars.

In another implementation, a rotor assembly used in an induction machine includes a rotor core having a plurality of conductor bar slots spaced circumferentially around the rotor core; a rotor shaft including a fluid supply channel configured to receive fluid from a fluid source; and conductor bars, received within the conductor bar slots, having a contoured outer surface with at least one recessed area and at least one contact surface that engages a bar-facing surface of the conductor bar slots.

In yet another implementation, a rotor assembly used in an induction machine includes a rotor core having a plurality of conductor bar slots spaced circumferentially around the rotor core; a rotor shaft including a fluid supply channel configured to receive fluid from a fluid source; and conductor bars, received within the conductor bar slots, having a contoured outer surface with at least one recessed area and a radial length that is shorter than the conductor bar slots.

### BRIEF DESCRIPTION OF THE DRAWINGS

FIG. 1 is a cross-sectional view depicting an implementation of a rotor assembly;

FIG. 2 is another cross-sectional view depicting an implementation of a rotor assembly;

FIG. 3 is a cross-sectional view depicting another implementation of a rotor assembly;

FIG. 4a is a cross-sectional view depicting a portion of an implementation of a rotor assembly fit into a stator;

FIG. 4b is another cross-sectional view depicting a portion of an implementation of a rotor assembly fit into a stator;

FIG. 5 is a cross-sectional view depicting yet another implementation of a rotor assembly;

FIG. 6 is a cross-sectional view depicting a portion of an implementation of a rotor assembly fit into a stator;

FIG. 7 is a graph depicting an estimate of a torque-speed curve using a rotor assembly;

FIG. 8 is another graph depicting an estimate of a torque-speed curve using a rotor assembly; and

FIG. 9 is another graph depicting an estimate of a torque-speed curve using a rotor assembly.

### DETAILED DESCRIPTION

An induction machine can include a rotor assembly having metal conductor bars circumferentially spaced around a rotor shaft and secured within slots of the assembly. Fluid channels formed in the rotor assembly can receive fluid from a source and communicate the fluid directly over an outer surface of the conductor bars, and/or within the bars, to reduce the temperature of the induction machine. The shape, location, and direction of the fluid channels can exist in a number of different iterations.

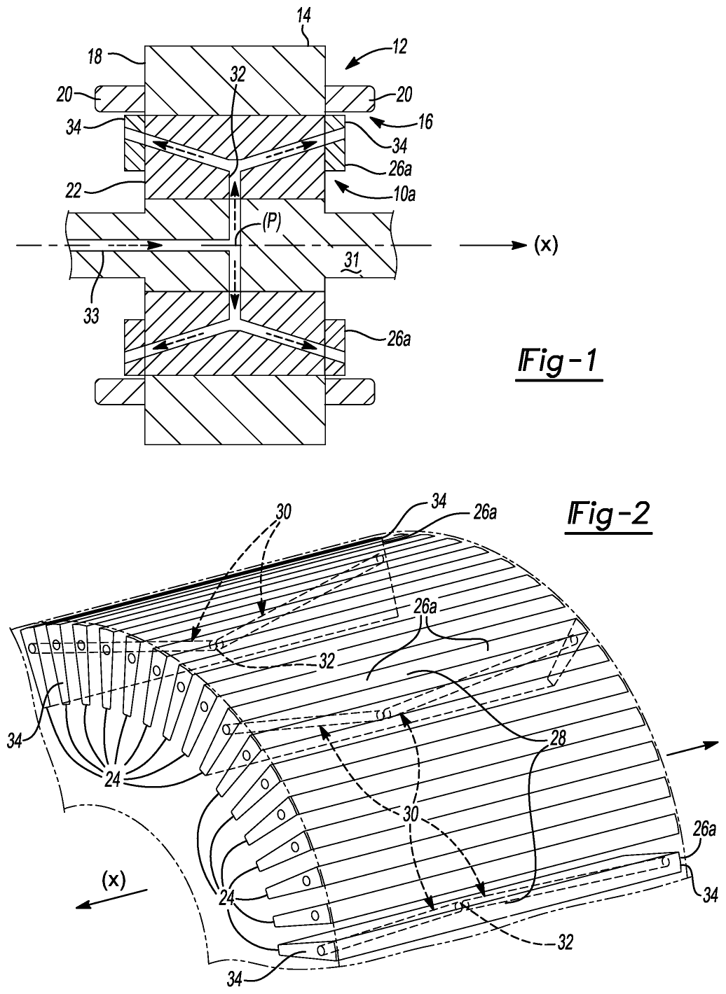

Turning to FIGS. 1 and 2, an implementation of a rotor assembly 10a received by an induction machine 12 is shown. Induction machines include the rotor assembly 10a and a stator 14, having stator windings 16, that receives the rotor assembly 10a. The stator windings 16 are received within stator slots (not shown) and can be exposed somewhat outside of the slots at a radial side 18 of the stator 14 at end turns 20. The stator windings 16, when conducting electrical current, angularly displace the rotor assembly 10a relative to the stator 14. The term “induction machine” or “induction motor” should be understood to mean an asynchronous rotating electrical machine or electric motor, which is different from a synchronous machine. The rotor assemblies described here are used by an induction machine or asynchronous rotating electrical machine and can conduct electric current through its conductor bars. A rotor core 22 can be formed from a stack of thin layers of steel that are aligned and axially extend along a rotor shaft axis (x). The layers comprising the stack can have a particular shape that, when combined, form conductor bar slots 24. For example, each layer can be shaped to closely follow an outer surface of conduction bars 26a so, when the bars 26a are received by the rotor assembly 10b within the conductor bar slots 24, the bars 26a are securely held by the assembly 10a during induction machine operation. The rotor core 22 and conductor bars 26a can be designed in different ways. For example, each conductor bar slot 24 in the rotor core 22 can include more than one conductor bar 26a and the bars 26a can be placed adjacent to each other in the slot 24 with a gap 28 in between the bars 26a. The gap 28 can form at least part of a fluid channel that can communicated fluid from a source over or through the conductor bars 26a. The layers can be bonded or otherwise mechanically joined together to form a unitary structure.

In this implementation of the rotor assembly 10a, the conductor bars 26a include at least one bore 30 formed within the surface of the bars 26a so that the bores 30 are non-parallel to the rotor shaft axis (x). The bores 30 can extend from one end 32 of the conductor bar 26a to another opposite end 34 of the conductor bar 26a. However, other implementations are possible in which the bore 30 extends from one point on an outer surface of the bar 26a to another point. The diameter of the bores 30 can vary depending on the flow rate desired. As the conductor bars 26a are positioned in the rotor core 22, the bores 30 are positioned to receive fluid near a midpoint (P) location of the rotor core 22, in between adjacent conductor bars 26a. Given the non-parallel orientation of the bores 30, one opening of the bore 30 will be closer to the fluid source than the other opening. The bores 30 can be formed as part of a casting process during conductor bar formation. Or in other implementations, the bores 30 can be milled after the conductor bars 26a have been formed. In the implementations discussed here, the conductor bars 26a can be made of copper, but other metals are possible, such as aluminum.

A rotor shaft 31 can be fixed to the rotor core 22 about the rotor shaft axis (x). In this implementation, the rotor shaft 31 can include a fluid supply channel 33 within the shaft such that the channel is open at one end of the shaft 31 to receive fluid from a fluid source (not shown). The fluid can move axially along the axis (x) to the midpoint (P) where the fluid can move radially-outwardly into the rotor core 22 and into the bores 30.

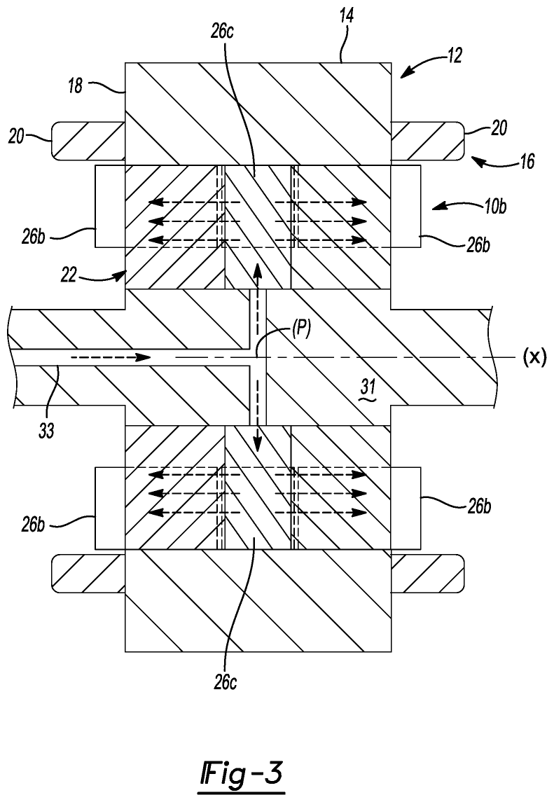

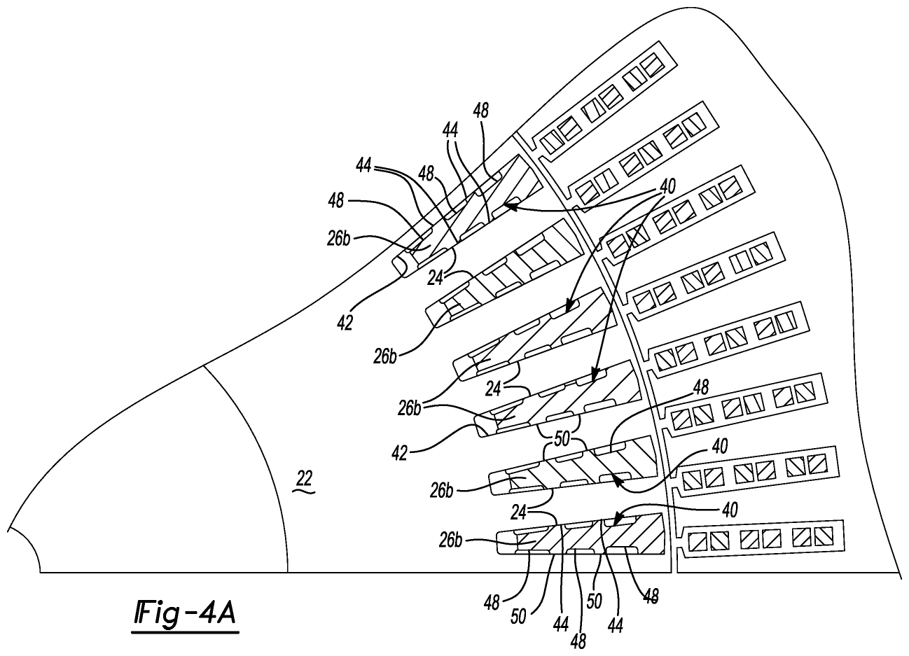

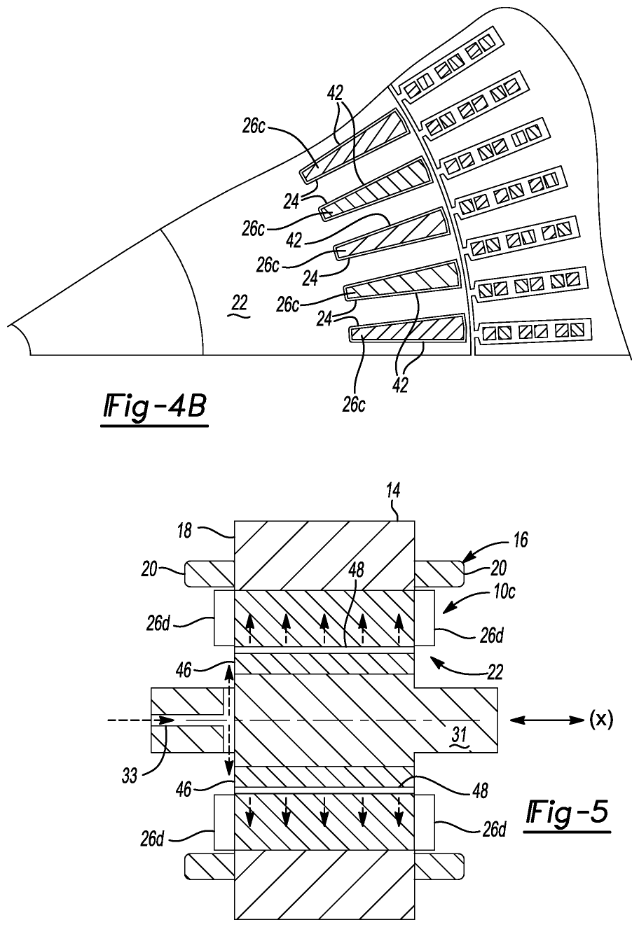

FIGS. 3, 4a, and 4b depict another implementation of a rotor assembly 10b received by the induction machine 12. The rotor assembly 10b can be formed from a stack of thin layers of steel that are aligned and axially extend along the rotor shaft axis (x). The layers comprising the stack can have a particular shape that, when combined, include conductor bar slots 24 and form a rotor core 22. For example, each layer can be shaped to closely follow an outer surface of the conduction bars 26b so, when the bars 26b are received by the rotor assembly 10b, they are securely held during induction machine operation. However, the relationship between an outer surface of the conductor bars and a bar-facing surface of the conductor bar slots can vary within the rotor assembly 10b. In this implementation, at least some portion of the conductor bar 26b can have a contoured outer surface 40 that at least partially forms a fluid channel between the outer surface 40 of the conductor bars 26b and the bar-facing surface 42 of the conductor bar slots 24 that directs fluid over the outer surface 40 of the bars 26b. The contoured outer surface 40 of the conductor bars 26b can also include a slot engaging surface 44 that directly abuts the bar-facing surface 42 of the conductor bars 26b. Other portions of the conductor bar 26c can have a reduced thickness that, when the bar 26c is positioned in the conductor bar slots 24, leaves space between the outer surface 40 of the bar 26c and the bar-facing surface 42 of the conductor bar slots 24. The space can permit fluid flow within the conductor bar slots 24 over an outer surface 40 of the conductor bars 26b/26c.

In this implementation, the rotor core 22 can receive the conductor bars 26b/26c within conductor bar slots 24. Each bar within one conductor bar slot 24 can have a different shape along the axial length of the bars 26; one portion of the bar 26b has one shape while another portion of the bar 26c has another different shape. The conductor bars 26b/26c having different shaped portions can fill conductor bar slots 24 extending circumferentially around the rotor core 22. The conductor bar 26b having the contoured outer surface 40 positioned adjacent to a radial face of the rotor core 22 can be referred to as an end stack whereas the conductor bar 26c having an different contoured outer surface positioned between the end stacks and extending circumferentially around the core 22 can be referred to as a middle stack. The middle stack can include conductor bars 26c having a shape in the form of a reduced thickness such that space exists between the conductor bar 26c and the bar-facing surface 42 of the conductor bar slot 24. The rotor shaft 31 can be coupled to the rotor assembly 10b along the rotor shaft axis (x) and include a fluid supply channel 31 extending axially along the rotor shaft axis (x) as well as radially outwardly from the axis (x) toward the middle stack. The fluid can travel axially along the rotor shaft axis (x) to a midpoint (P) where the fluid can then move radially outwardly from the axis (x) through into the rotor core 22 and into the conductor bar slots 24 of the middle stack. As the fluid flows radially outwardly, the fluid contacts the conductor bars 26c having the reduced thickness. Rotation of the rotor assembly 10b can draw the fluid axially toward the end stack.

The conductor bars 26b in the end stacks can have the contoured surface 40 that both permits fluid flow axially within the conductor bar slots 24 parallel to the rotor shaft axis (x) over the contoured outer surface 40 of the bars 26b and directly contacting the bar-facing surface 42 of the slots 24 to firmly position the bars 26b within the rotor core 22. For example, the contoured surface 40 can at least partially be created by recessed areas 48 on the outer surface 40 of the conductor bars 26b that extend from one end of the bar 26b adjacent to the middle stack and another end of the bar 26b adjacent to the radial face 46 of the rotor core 22. The recessed area 48 can form part of a fluid channel and permit fluid flow from the middle stack along the outer surface 40 of the conductor bars 26b within the end stack to the radial face 46 of the rotor core 22, exiting the core 22 and then flowing radially outwardly over the end turns 20 of the stator 14. In addition, the conductor bars 26b can have a contact surface 50 that firmly locates the bars 26b within the slots 24 and prevents movement of the bars 26b within the slots 24.

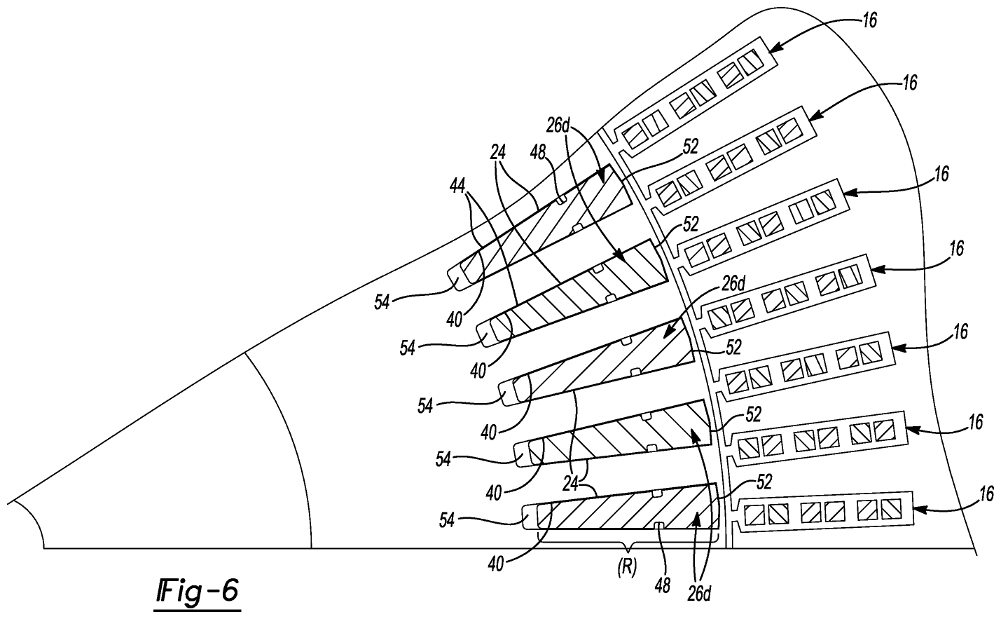

Another implementation of the rotor assembly 10c is shown in FIGS. 5 and 6. The rotor assembly 10c uniformly includes conductor bars 26d, within conductor bar slots 24, having a contoured surface that both permits fluid flow axially within the conductor bar slots 24 parallel to the rotor shaft axis (x) over the contoured outer surface 40 of the bars 26d and directly contacting the bar-facing surface 42 of the slots 24 to firmly position the bars 26d within the rotor core 22. For example, the contoured surface 40 can at least partially be created by recessed areas 48 on the outer surface 40 of the conductor bars 26d that extend from one end of the bar 26d to another end of the bar 26d adjacent to the radial face 46 of the rotor core 22. The recessed area 48 can form part of a fluid channel and permit fluid flow over the outer surface 40 of the conductor bars 26d to the radial face 46 of the rotor core 22, exiting the core 22 and then flowing radially outwardly over the end turns 20 of the stator 14. The rotor core 22 can be extruded and formed to retain the bars 26 in place during operation. The close fit between the bars 26 and the rotor core 22 can also aid in cooling the assembly. In addition, the conductor bars 26d can have a contact surface 50 that firmly locates the bars 26d within the slots 24 and prevents movement of the bars 26d relative to the slots 24. The conductor bars 26d can also be sized such that they have a radial length (R) that is less than the radial length than the conductor bar slot 24. As the conductor bars 26d are received within the conductor bar slots 24, a distal end 52 of the bars 26d can directly abut a portion of the slot 24 while a fluid channel can be formed between the bars 26d and a bar-facing surface 42 of the slots 26d at an area 54 nearest the rotor shaft axis (x). In that sense, the fluid channel can include the recessed area 48 as well as the area 54 between the bars and the slots.

The rotor shaft 31 can be coupled to the rotor assembly 10d along the rotor shaft axis (x) and include a fluid supply channel 33 extending axially along the rotor shaft axis (x) as well as radially outwardly toward the rotor core 22. The fluid can travel through the fluid supply channel 33 to an endpoint (E) where the fluid can then move radially outwardly from the axis (x) along the radial face 46 of the rotor core 22 where the fluid can be drawn into the conductor bar slots 24 and communicated axially parallel with the rotor shaft axis (x). Rotation of the rotor assembly 10d can draw the fluid axially toward an opposite radial face 56 of the rotor core 22.

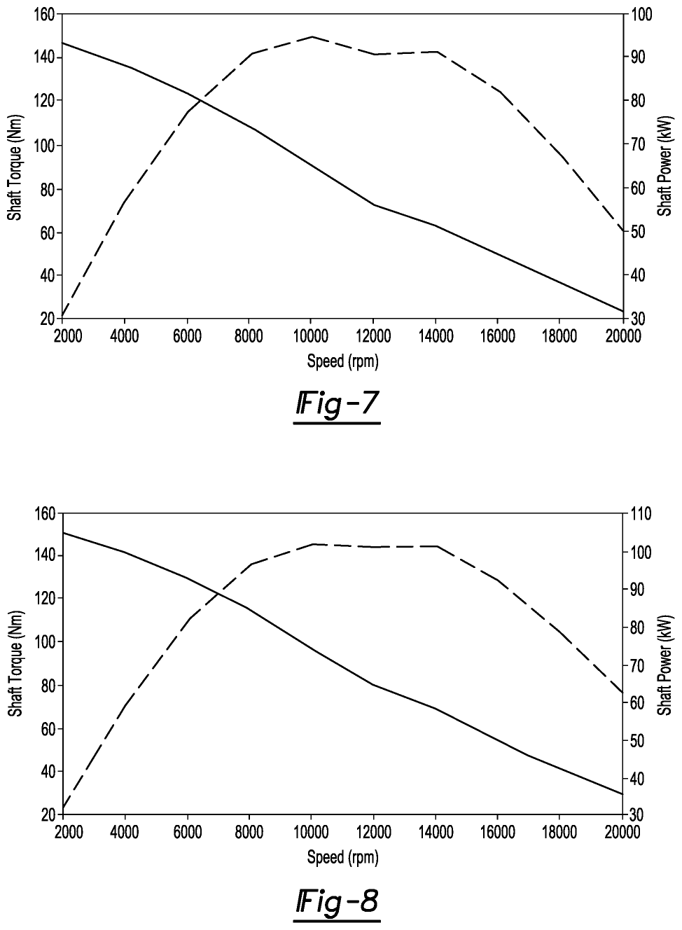

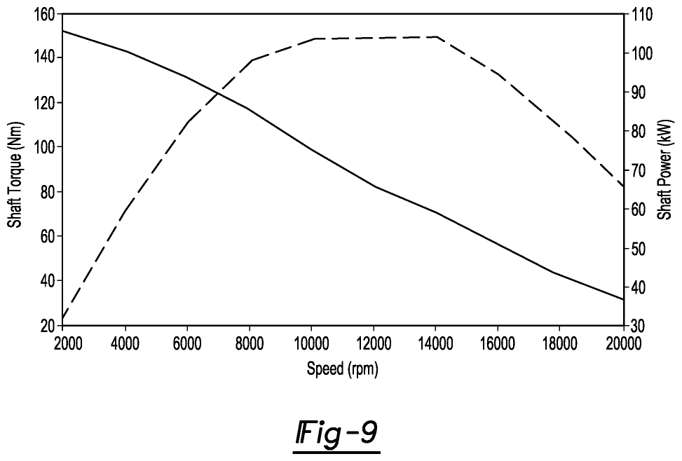

FIGS. 7-9 depict performance estimation of rotor assemblies without the fluid channels, with fluid channels inside the conductor bars, and with fluid flowing on an outside surface of the conductor bars, respectively. FIG. 7 depicts an estimate of a torque-speed curve for induction machines without conductor bar cooling having ˜147 Nm for torque and ˜93 kW for power. FIG. 8 depicts an estimate of a torque-speed curve for induction machines with bores within conductor bars to assist cooling having ˜151 Nm for torque and 102 kW for power. And FIG. 9 depicts an estimate of a torque-speed curve for induction machines with fluid flow over an outer surface of conductor bars to assist cooling having ˜152 Nm for torque and 110 KW for power.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A rotor assembly used in an induction machine, comprising:
a rotor core having a plurality of conductor bar slots spaced circumferentially around the rotor core;
a rotor shaft including a fluid supply channel configured to receive fluid from a fluid source; and
conductor bars, received within the conductor bar slots, that receive fluid from the fluid supply channel through bores formed in the conductor bars or over an outer surface of the conductor bars.

2. The rotor assembly recited in claim 1, further comprising bores that are non-parallel with a rotor shaft axis.

3. The rotor assembly recited in claim 1, further comprising a plurality of conductor bars axially placed within a single conductor bar slot and a gap between the conductor bars receiving fluid radially outwardly from a rotor shaft axis.

4. The rotor assembly recited in claim 1, further comprising conductor bars with a contoured outer surface.

5. The rotor assembly recited in claim 4, wherein the contoured outer surface comprises a recessed area.

6. The rotor assembly recited in claim 4, wherein the contoured outer surface comprises a contact surface that abuts a bar-facing surface of the conductor bar slot.

7. The rotor assembly recited in claim 1, wherein the fluid exits the rotor core and moves radially outwardly to contact end turns of a stator.

8. The rotor assembly recited in claim 1, wherein the fluid from the fluid supply channel is initially supplied to a radial face of the rotor core.

9. A rotor assembly used in an induction machine, comprising:
a rotor core having a plurality of conductor bar slots spaced circumferentially around the rotor core;
a rotor shaft including a fluid supply channel configured to receive fluid from a fluid source; and
conductor bars, received within the conductor bar slots, having a contoured outer surface with at least one recessed area and at least one contact surface that engages a bar-facing surface of the conductor bar slots.

10. The rotor assembly recited in claim 9, further comprising an end stack including conductor bars having the contoured outer surface and a middle stack including conductor bars having a reduced thickness.

11. The rotor assembly recited in claim 9, further comprising a plurality of conductor bars axially placed within a single conductor bar slot and a gap between the conductor bars receiving fluid radially outwardly from a rotor shaft axis.

12. The rotor assembly recited in claim 9, wherein the fluid exits the rotor core and moves radially outwardly to contact end turns of a stator.

13. A rotor assembly used in an induction machine, comprising:
a rotor core having a plurality of conductor bar slots spaced circumferentially around the rotor core;
a rotor shaft including a fluid supply channel configured to receive fluid from a fluid source; and
conductor bars, received within the conductor bar slots, having a contoured outer surface with at least one recessed area and a radial length that is shorter than the conductor bar slots.

14. The rotor assembly recited in claim 13, wherein the conductor bars received within the conductor bar slots are uniformly shaped.

15. The rotor assembly recited in claim 13, wherein the fluid exits the rotor core and moves radially outwardly to contact end turns of a stator.
